(19) United States
(12) Patent Application Publication
(10) Pub. No.: US 2003/0097338 A1
(43) Pub. Date: May 22, 2003

(54) Method and system for purchasing content related material

(75) Inventors: Nicholas J. Mankovich, Yorktown Heights, NY (US); Michael A. Epstein, Spring Valley, NY (US); Antonius A. M. Staring, Eindhoven (NL)

Correspondence Address: Jack E Haken, c o U S Philips Corporation, Intellectual Property Department, 580 White Plains Road, Tarrytown, NY, 10591, US

(73) Assignee: PIOTROWSKI TONY E.

(21) Appl. No.: 09/498,261

(22) Filed: Feb. 3, 2000

(51) Int. Cl. G06F 17/60

(52) U.S. Cl. 705/64

(57) ABSTRACT

A “buy” button is provided on devices that receive content material to facilitate a purchase of content related material as the content material is being presented to a consumer. If, while listening to or viewing content material from a provider, the consumer decides the purchase the content material, or an item associated with the content material, the consumer activates a “buy” button on the device that is rendering the content material. The rendering device associates an item identifier associated with the content material to this “buy” command, and forms a purchase request containing this item identifier. If the rendering device has a receive-only capability relative to the provider of the content material, the purchase request is stored until the rendering device is brought in contact with a content access device that is able to transmit to the provider. The purchase request, including certification information such as a customer identification number, a credit card number, and the like, is communicated to the provider by the content access device or by a rendering device that is able to transmit to the provider. In a preferred embodiment, to facilitate a purchase of copy-controlled content material, the rendering device includes a memory that stores the content material while it is being received, and a controller that controls access to this memory until an access authorization is received from the provider in response to the purchase request. A transfer device is also provided that facilitates the communication of purchase requests and content material between the content access device and other rendering devices.

### BACKGROUND OF THE INVENTION

1. Field of the Invention

This invention relates to the field of consumer electronics, and in particular to consumer devices that facilitate e-commerce.

2. Description of Related Art

Electronic commerce provides unprecedented opportunities for consumers to purchase products, and also provides opportunities for alternative market and sales techniques. Conventionally, electronic commerce requires a somewhat pro-active consumer role. The consumer searches the Internet for a particular product, selects a vendor, and submits a purchase request. Alternatively, a consumer visits a web-site for information, perhaps with no intent to purchase anything, and is presented an advertisement for a product. The consumer ‘clicks’ on the advertisement, decides whether to purchase the item, and then submits the purchase request. In like manner, the consumer receives e-mail containing an advertisement, reviews the information, either directly or via an Internet link, decides whether to purchase the product, and submits a purchase request. In each of these scenarios, the consumer utilizes a bi-directional communications device to contemporaneously receive the information and submit the purchase request.

In like manner, the purchase of entertainment material, such as a pay-per-view movie from a cable service, or a music selection from an Internet site, requires that the consumer submit a purchase request before the material is provided. Typically, this involves a “considered choice”, and a relatively pro-active effort, on the part of the consumer, and requires the aforementioned bi-directional communications link at the time that the consumer decides to make the purchase.

As is well known in the art of marketing and advertising, “impulse buying” provides an opportunity for significant product revenues. Products are placed within easy reach while waiting in a cashier queue, “specials” are announced over loud-speaker systems in a department store, and so on. Television commercials often contain a notification of a telephone number to call to order a product being advertised, or to order a copy of the program being broadcast at that time. This technique has been applied to e-commerce systems, for example, by providing “click here to purchase” icons on web-page or e-mail advertisements. The opportunities for impulse buying, however, are limited to the specific environments or occasions that allow for such impulse buys, and, in the case of e-commerce, typically requires a contemporaneous bi-directional communications link between the consumer and the product supplier.

### BRIEF SUMMARY OF THE INVENTION

It is an object of this invention to provide devices and techniques that facilitate impulse buying via electronic-commerce. It is a further object of this invention to provide a purchasing process that facilitates the purchase of copy protected content material. It is a further object of this invention to provide a system that facilitates the purchase and transfer of content material to portable devices.

These objects, and others, are achieved by providing devices that can be used to initiate a purchase of content material as the content material is being presented to a consumer. If, while listening to or viewing content material from a provider, the consumer decides the purchase the content material, or an item associated with the content material, the consumer activates a “buy” button on the device that is rendering the content material. The rendering device associates an item identifier associated with the content material to this “buy” command, and forms a purchase request containing this item identifier. If the rendering device has a receive-only capability relative to the provider of the content material, the purchase request is stored until the rendering device is brought in contact with a content access device that is able to transmit to the provider. The purchase request, including certification information such as a customer identification number, a credit card number, and the like, is communicated to the provider by the content access device or by a rendering device that is able to transmit to the provider. In a preferred embodiment, to facilitate a purchase of copy-controlled content material, the rendering device includes a memory that stores the content material while it is being received, and a controller that controls access to this memory until an access authorization is received from the provider in response to the purchase request. A transfer device is also provided that facilitates the communication of purchase requests and content material between the content access device and other rendering devices.

### BRIEF DESCRIPTION OF THE DRAWINGS

The invention is explained in further detail, and by way of example, with reference to the accompanying drawings wherein:

FIG. 1 illustrates an example block diagram of a content receiver and portable device in accordance with this invention.

FIG. 2 illustrates a more detailed example block diagram of a content receiver in accordance with this invention.

FIGS. 3A-3B illustrates an example block diagram of a transfer device in accordance with this invention.

FIG. 4 illustrates an example block diagram of an alternative portable device in accordance with this invention.

FIG. 5 illustrates a more detailed example block diagram of an alternative portable device in accordance with this invention.

FIG. 6 illustrates an example block diagram of an alternative transfer device in accordance with this invention.

Throughout the drawings, the same reference numerals indicate similar or corresponding features or functions.

### DETAILED DESCRIPTION OF THE INVENTION

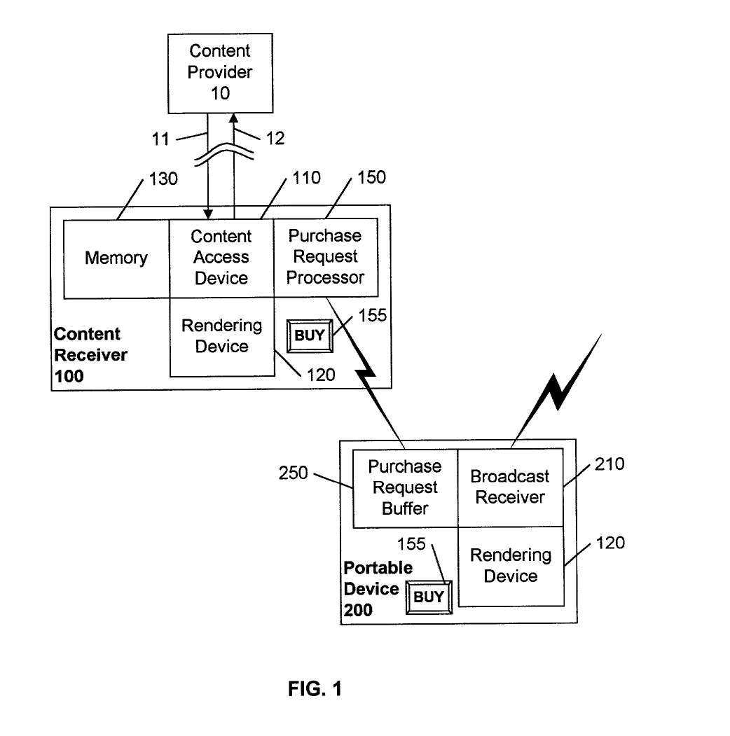

FIG. 1 illustrates an example block diagram of a content receiver 100 and portable device 200 in accordance with this invention. The example content receiver 100 includes a content access device 110, a rendering device 120, a memory 130, and a purchase request processor 150. Although the content receiver 100 is illustrated as a single entity in FIG. 1, any number of alternative physical configurations may be utilized, such as distributed or networked set of system components, or a mix of hardware and software components having a common or distributed processing system, and so on, as would be evident to one of ordinary skill in the art. The content access device 110 provides bi-directional communications with a content provider 10 for receiving content material 11 from the content provider 10, and for communicating information 12 to the content provider 10. This bi-direction communications may include the use of a common communications channel, or multiple communications channels, in a continuous or discontinuous mode, and can include, for example an Internet access to provide one or both of the bi-directional paths. The rendering device 120 provides a rendering of the content material to a user. For example, if the content material is an audio recording, the rendering device produces the audible signals corresponding to the audio recording. If the content material is video, the rendering device 120 provides a visual image sequence corresponding to the video recording. For ease of reference, the rendering device 120 is illustrated as being integral with the content receiver 100, although discrete components, such as a stereo system, a television system, a recording or playback device, loudspeakers, headphones, monitors, and so on, may form the rendering device 120, while the content receiver 100 could be a set top box, an Internet access device, or other communications device.

In accordance with one aspect of this invention, the content material 11 is provided from the content provider 10 for a once-only rendering. If a consumer decides to purchase the content material 11 while it is being rendered, or within a particular time frame during and after the rendering, the consumer initiates a purchase, via for example, the “buy” button 155, that is processed by the purchase request processor 150. For the purposes of this invention, the term “purchase” is used herein to indicate an acquisition of rights, and can include, for example, a lease or rental of the content material for a limited period, an acquisition of playback rights with or without copy rights, a re-purchase of expired rights, an acquisition of alternative forms of the content material, and so on. The processed purchase request contains the appropriate information for executing a purchase, such as a customer identification number, a credit card number, a personal identification number (PIN), or other such information that certifies the purchase as being authentic. The processed purchase request also includes an identification of the content material 11 being purchased. The content access device 110 communicates the processed purchase request 12 to the content provider 10, and optionally, receives an acknowledgement from the content provider 10, via the same or alternative communications path that the content material 11 is received.

Depending upon the capabilities of the content receiver 100, the type of material being purchased, options selected by the consumer, and so on, the purchase request 12 is fulfilled by the content provider 10 in a variety of ways. In a straightforward embodiment, the content provider 10 provides the purchased material in a conventional manner, such as mailing a tape, disc, or other medium that contains a copy of the content material 11 to the consumer.

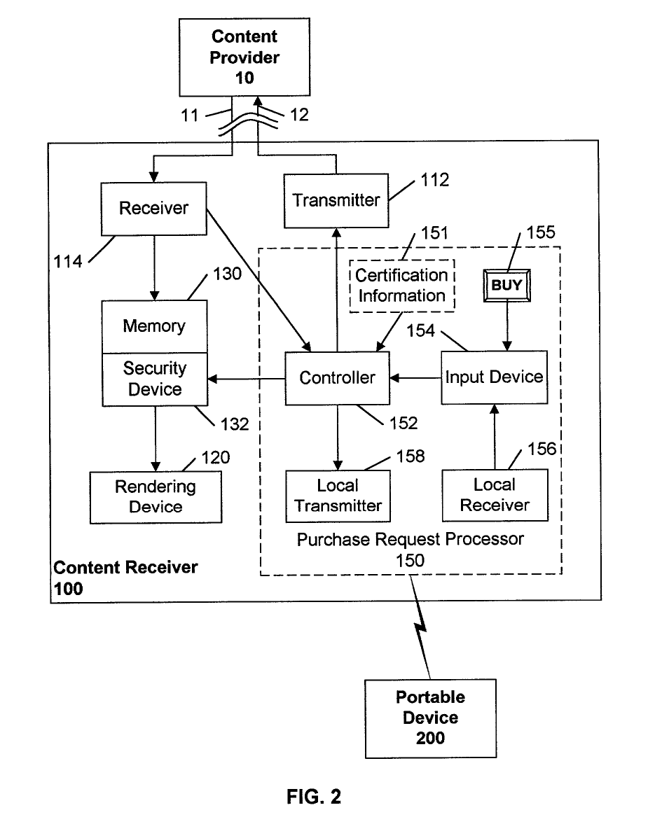

In accordance with another aspect of this invention, the content material 11 is stored in the memory 130 at the same time that is being rendered, but the system is configured so as to preclude a subsequent rendering of the recorded content material 11 until a purchase request 12 is submitted, and an authorization for subsequent renderings is received from the content provider 10. This process is illustrated in the example block diagram of the content receiver 100 in FIG. 2.

As illustrated in FIG. 2 the example content receiver 100 includes a memory 130 with integral security device 132. The integral security device 132 may include circuitry or software code that controls access to the memory 130, or it may include a private key that is used by a controller 152 to control access to the memory 130, as discussed further below. In operation, the controller 152 receives a command from an input device 154 to submit a purchase request to the content provider 10. In a preferred embodiment, the aforementioned certification information (credit card number, etc.) is available 151 within the content receiver 100, so as to facilitate the use of a single “buy” button associated with the input device 154 to initiate a purchase request. Note that by providing a “buy” button 155, the consumer is provided a simple and straightforward means of executing an impulse buy while viewing or listening to the content material that is being purchased. As would be evident to one of ordinary skill in the art in light of this disclosure, a corresponding “buy” button 155 can be provided on a conventional remote control device (not shown) to further increase the ease of executing this impulse buy. The controller 152 submits a processed purchase request to the provider 10 via a transmitter 112. To minimize potential errors, the purchase request in a preferred embodiment includes an identification of the content material being purchased. This identification may be provided by a unique code that is transmitted from the content provider 10 with each content material item, and provided to the controller 152 via the receiver 114.

In response to the submitted purchase request, the content provider 10 communicates an authorization to the controller 152, via the receiver 114, for subsequent renderings of the content material from the memory 130. Any of a number of techniques may be utilized to effect this once-only-unless-authorized rendering process. A cost-effective method of copy protection is discussed in detail by Jean-Paul Linnartz et al., in Philips Electronics Response to Call for Proposals Issued by the Data Hiding Subgroup Copy Protection Technical Working Group, July 1997 (“Linnartz”). The Linnartz scheme operates by attaching a “ticket” to the recorded material; the ticket comprises a verifiable “count” that is decremented at each stage of the playback and recording process, and is computationally difficult to increment. Copending U.S. patent application, “Copy Protection by Ticket Encryption”, Ser. No. 09/333,628, filed Jun. 15, 1999 for Michael A. Epstein, Attorney Docket PHA 23,457, further enhances this ticketing scheme by establishing a secure communications channel that is exclusive to the devices that are exchanging the protected content material, and is incorporated by reference herein. To utilize this ticketing scheme in this invention, the content material is communicated to the content receiver 100 with a “render-once” ticket. In response to the received purchase request, the content provider 10 securely communicates the “render-always” ticket corresponding to the purchased content material. Alternative means of controlling the rendering of content material, such as time-limited ticketing schemes and the like, may also be utilized. In a less secure embodiment, the security device 132 may merely be a gate that the controller 152 controls after the first rendering of the content material, in dependence upon whether a purchase request has been submitted. Note that the memory 130 may include an external memory device, such as a VCR, a CD-R/W recorder, a cassette recorder, and the like, and may include the recording of the content material 11 on a removable medium, such as a flash memory device, a laser disc, a magnetic tape, and so on. In another alternative embodiment, the controller 152 may be configured to retain the content material 11 in an internal volatile memory area until a purchase request is submitted, and thereafter transfer the content material 11 from the internal memory area to a removable medium, for use via other rendering devices.

Note that the above description has been limited to the purchase of content material 11 that is communicated by the content provider 10 for rendering by the content receiver 100. The principles and techniques presented above may also be used to purchase material that is associated with the content material 11, rather than the content material itself For example, if a commercial advertisement is being broadcast as “content material” 11, the aforementioned identification of the content material will identify the product being advertised, and the purchase request will be for the advertised material, rather than for the advertisement. In like manner, the system may be augmented to allow for a selection among purchased items. For example, the content material 11 may be a musical video presentation, and the consumer is given an option of purchasing the video or the soundtrack that is associated with the video, or both. To provide consumer options, the controller 152 is configured to present information via the rendering device 120, using techniques common in the art, such as those used to present set-up menu options on a television screen from a VCR, and the like. Such display techniques may also be utilized to present a confirmation notice, or other information, to the consumer.

The principles presented above to facilitate impulse buying can also be extended to portable devices, thereby further increasing the opportunities for such impulse buying. FIG. 1 also illustrates an example block diagram of a portable device 200 that can be used to effect an impulse buy. The portable device 200 includes a broadcast receiver 210, a rendering device 120, a “buy” button 155, and a purchase request buffer 250. The broadcast receiver 210 receives content material. If the consumer desires to purchase the content material, or an item associated with the content material, the consumer presses the “buy” button 155. The purchase request buffer stores an identification of the content material corresponding to this purchase request. As noted above, this identification of the content material is broadcast with the broadcast content material, typically as a preamble or postscript to each item of content information. Alternatively, the identification may be provided via another broadcast channel, or it may be encoded or hidden within the content information, using, for example, digital watermarks and the like. These and other techniques for identification are common in the art. In Europe, for example, the RDS (Radio Data System) is commonly used to provide meta-data along with an analog radio broadcast. Preferably, the buffer 250 is structured to allow for the storage of multiple identifications of purchased items.

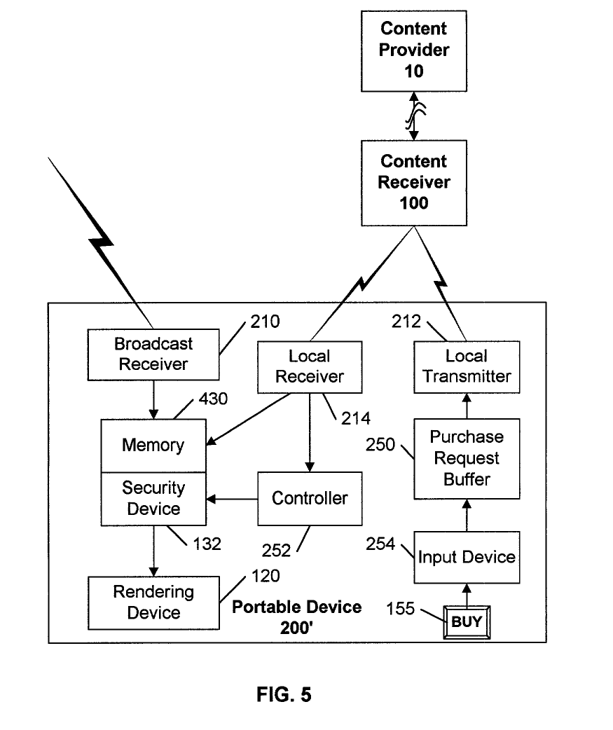

When the portable device 200 is brought to the vicinity of the content receiver 100, the stored purchase requests are communicated to the purchase request processor 150 of the content receiver 100. As illustrated in FIG. 2, the content receiver 100 in a preferred embodiment includes a local receiver 156 for receiving the information from the portable device 200. The portable device 200 includes a corresponding local transmitter (212 in FIG. 5). The portable device 200 in an example embodiment includes an infrared transmitter, and the content receiver 100 includes an infrared receiver, common in the art of remote control devices. The communication of this information can be initiated by the consumer by pressing an appropriate button (not illustrated) on the portable device 200, or a protocol can be implemented wherein the transfer of information occurs whenever the portable device 200 comes in range of the content receiver 100. In such an embodiment, either the content receiver 100 or portable device 200 periodically transmits a beacon signal, and the communication is initiated when the beacon signal is recognized and acknowledged by the receiving device. Alternative transfer techniques are common in the art, including for example, providing a port on the content receiver 100 for receiving the portable device 200.

In response to the receipt of purchase requests from the portable device 200, the content receiver 100 communicates a corresponding processed purchase request, containing the aforementioned certification information 151, to the content provider 10 for execution. Depending upon the particular request and the capabilities of the content receiver 100, the content provider 10 fulfills the purchase request by shipping the requested material to the consumer, or by transmitting the content material 11 directly to the content provider 10 with an appropriate rendering authorization.

Note that, relative to the portable device 200 and this aspect of the invention, the content receiver 100 may be a conventional set-top box, without the aforementioned memory 130 or security device 132, that merely acts as a communications link with the content provider 10. If the content provider offers “on-demand” service, the content material can be communicated to the content receiver directly; if the content provider 10 offers the content material periodically on a pay-per-view or similar basis, the purchase order 12 may serve to provide the content material at the next scheduled transmission time; otherwise, the content provider 10 may deliver the content material by mail. Similarly, relative to the portable device 200 and this aspect of the invention, the purchase request processor 150 may be embodied in a computer system with internet access, wherein the stored purchase request in the portable device 200 is processed by the computer system, and thereafter communicates a purchase request via e-mail or similar means to a vendor of the content material. For ease of reference, the term content receiver 100 is used herein relative to the portable device to include such alternative means of communicating a processed purchase request to the content provider.

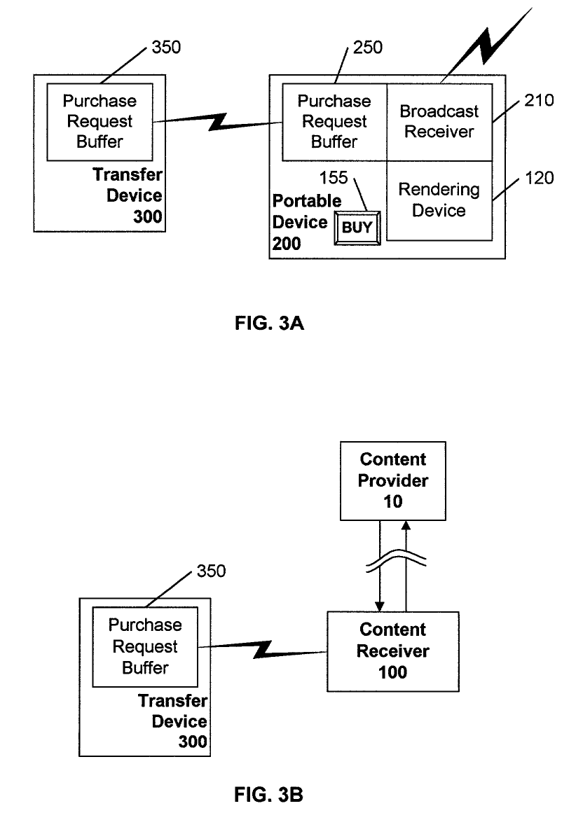

By providing a purchase request buffer for storing impulse purchase requests while the content material is being rendered, the opportunities for impulse buying are substantially increased compared to the traditional methods of purchasing material from a content provider. These opportunities may be further enhanced by providing a transfer device to facilitate the transfer of purchase requests from a portable device to a content receiver. Some portable devices, such as vehicular radios, are not easily brought into the vicinity of a typical content receiver having transmit capabilities to a provider, such as a home audio-video system with cable access. FIGS. 3A-3B illustrates an example block diagram of a transfer device 300 that facilitates the transfer of purchase requests from a portable device 200 to a content receiver 100 in accordance with this invention. In FIG. 3A, the transfer device 300 is brought into the vicinity of the portable device 200, and any stored purchase requests in the purchase request buffer 250 are transferred to the purchase request buffer 350. As stated above, any of a variety of techniques can be utilized to transfer the requests from the buffer 250, including infrared transmissions, direct communication via a port on the portable device 200 for receiving the transfer device 300, and so on. In FIG. 3B, the same transfer device 300 is brought into the vicinity of a content receiver 100. Again, using any of a variety of techniques, the requests from the portable device 200 that are stored in the purchase request buffer 350 of the transfer device 300 are transferred to the content receiver 100. The content receiver 100 processes and submits the purchase request to the content provider 10, as discussed above with respect to transfers from the portable device 200 to the content receiver 100 of FIG. 1.

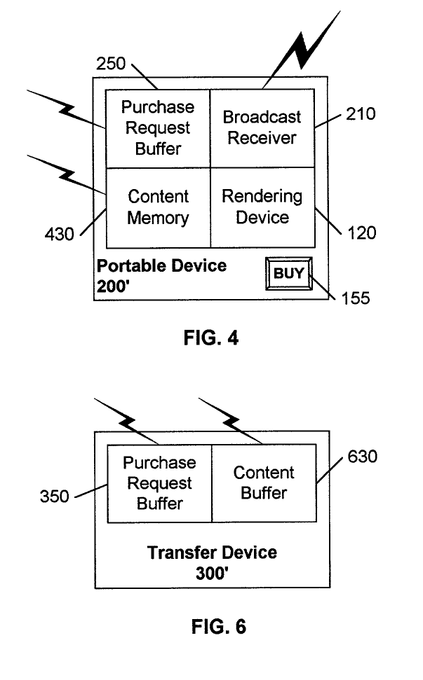

FIG. 4 illustrates an example block diagram of an alternative portable device 200′ in accordance with this invention. In this example embodiment, the portable device 200′ includes a content memory 430, similar to the content memory 130 of the content receiver 100. The content memory 430 in a preferred embodiment of this invention can receive content material directly, for example, from a content receiver 100, or via the broadcast receiver 210. FIG. 5 illustrates a more detailed example block diagram of the alternative portable device 200′. Similar to the content receiver 100 of FIG. 2, a controller 252 controls the rendering of the contents of the memory 430 via a security device 132. In a preferred embodiment of this invention, content material that is received from the broadcast receiver 210 is rendered once from the memory 430, typically while the material is being stored in the memory 430.

When the “buy” button 155 is pressed, the input device 254 stores the request in the purchase request buffer 250. When the portable device 200′ is brought in the vicinity, or coupled to, a content receiver 100, the purchase request is transferred from the purchase request buffer 250 to the content receiver 100 via the local transmitter 212. The content receiver 100 processes and transfers the processed purchase request to the content provider 10 for execution. If the purchase request is for a rendering authorization for the content material that is stored in the memory 430, the authorization is communicated to the controller 252 via the local receiver 214. In like manner, the transfer device 300 of FIGS. 3A-3B can be configured to communicate the authorization to the portable device 200′ after receiving it from the content receiver 100. If the purchase request is for another copy of the content material, such as a digital copy of the material that was broadcast in analog form, the content receiver 100 receives the content material from the content provider 10, and transfers the material to the memory 430 via the local receiver 214.

FIG. 6 illustrates an example block diagram of an alternative transfer device 300′ in accordance with this invention. Copending U.S. patent application “Virtual Jukebox”, Ser. No. 09/326,506, filed Jun. 4, 1999 for Pieter van der Meulen, Attorney Docket PHA 23,417, discloses the storage of a collection of MPEG or Philips' DCC audio compressed audio recordings on a conventional hard drive, and is incorporated by reference herein. This patent application discloses the feasibility of storing hundreds of CD-length recordings on a conventional 10 GB hard disk drive, and specifically notes its utility in vehicular audio systems. In a preferred embodiment of this invention, the transfer device 300′ contains a content buffer 630 with a capacity of 40 megabytes, thereby allowing for the storage of the contents of a typical full-length (50 minute) audio CD in an MPEG or Philips' DCC audio compressed format. As presented in FIGS. 3A-3B, the transfer device 300′ receives a purchase request from a portable device 200, such as a vehicular mounted radio receiver, and communicates it to a content receiver 100 when it is brought to the vicinity, or coupled to, the content receiver 100. In accordance with this aspect of the invention, the transfer device 300′ receives the content information from the content receiver 100 and transfers it to the portable device 200, via its content buffer 630, when it is brought to the vicinity of, or coupled to, the portable device 200.

The foregoing merely illustrates the principles of the invention. It will thus be appreciated that those skilled in the art will be able to devise various arrangements which, although not explicitly described or shown herein, embody the principles of the invention. For example, in a multiple-user environment, each portable device 200 may include a unique user identification, and the content receiver 100 may provide different certification information 151 in dependence upon the unique user identification associated with each received purchase request. Alternatively, the portable device 200 may include the certification information 151 associated with each individual user, and include the processing capabilities to provide a complete processed purchase request. In this embodiment, the content receiver need merely be a system that transfers the processed purchase request to a content provider. For example, such a system may be embodied in a public kiosk that the consumer drives through to place processed purchase requests that are stored in the consumer's vehicular or personal portable device's purchase request buffer. If the kiosk is at the location of the content provider, the purchased item could be subsequently provided to the consumer directly. These and other system configurations and optimizations will be evident to one of ordinary skill in the art in view of this disclosure and are within the spirit and scope of the following claims.

We claim:

1. A receiving system comprising:
a content access device that is configured to receive content material and an item identifier associated with the content material from a provider, and
a purchase request processor, operably coupled to the content access device and an input device, that is configured to receive a purchase request from the input device and the item identifier from the content access device, and produces therefrom a processed purchase request, and
wherein
the content access device is further configured to communicate the processed purchase request to the provider.

2. The receiving system of claim 1, further comprising:
a rendering device, operably coupled to the content access device, that is configured to render the content material, and
wherein
the content access device is further configured to associate the purchase request and the item identifier based on a coincidence of a time of receipt of the purchase request and a time interval associated with the rendering of the content material.

3. The receiving system of claim 1, further comprising:
a memory, operably coupled to the content access device, that is configured to store the content material, and
wherein
the content access device is further configured to control access to the content material in the memory, the control access being dependent upon a receipt of an authorization from the provider in response to the processed purchase request.

4. The receiving system of claim 1, wherein
the purchase request processor is further configured to receive a transferred purchase request and a transferred item identifier, and to produce therefrom the processed purchase request.

5. The receiving system of claim 1, wherein
the purchase request processor is further configured to receive certification information associated with the purchase request, and
wherein
the processed purchase request includes the certification information.

6. The receiving system of claim 1, further including:
a “buy” switch, and
wherein
the purchase request from the input device is produced in response to an activation of the “buy” switch.

7. A portable device comprising:
a broadcast receiver that is configured to receive content material and an item identifier associated with the content material from a broadcast source,
a rendering device that is configured to render the content material, and
a purchase request buffer that is configured to store a purchase request and the item identifier to facilitate a subsequent purchase of an item corresponding to the item identifier.

8. The portable device of claim 7, further including
a controller that associates the purchase request and the item identifier based on a coincidence of a time of receipt of the purchase request and a time interval associated with the rendering of the content material.

9. The portable device of claim 8, wherein
the controller is further configured to receive certification information associated with the purchase request, and
wherein
the purchase request buffer further includes the certification information.

10. The portable device of claim 8, further comprising:
a memory, operably coupled to the broadcast receiver, that is configured to store the content material, and
wherein
the controller is further configured to control access to the content material in the memory, the control access being dependent upon a receipt of an authorization in response to a communication of the purchase request to a provider.

11. The portable device of claim 7, further including:
a “buy” switch, and
wherein
the purchase request is provided in response to an activation of the “buy” switch.

12. A transfer device comprising:
a purchase request buffer that is configured to:
receive a purchase request from a first device, and
transmit the purchase request to a second device.

13. The transfer device of claim 12, further comprising
a memory that is configured to:
receive content material from the second device in response to the purchase request, and
transmit the content material to the first device.

14. The transfer device of claim 12, wherein
the first device includes a memory that contains content material and a controller that controls access to the content material based on an authorization, and
the purchase request buffer is further configured to:
receive the authorization from the second device in response to the purchase request, and
transmit the authorization to the first device.

15. A method for facilitating a purchase of an item associated with content material, the process comprising:
receiving the content material and an identifier of the item,
rendering the content material,
receiving a buy command at a time that is coincident with a time interval associated with the rendering of the content material,
creating a purchase request that includes the identifier of the item in response to the buy command, and
communicating the purchase request to a provider of the item.

16. The method of claim 15, wherein
receiving the buy command includes receiving an activation signal associated with an activation of a “buy” switch.

17. The method of claim 15, further including:
storing the content material, and
controlling access to the content material based on receiving the buy command.

18. The method of claim 17, wherein
controlling access is further dependent upon receiving an authorization from the provider in response to the purchase request.

19. The method of claim 15, further including
transferring the purchase request to one or more intermediary devices, and
wherein
communicating the purchase request to the provider is via the one or more intermediary devices.

20. The method of claim 15, further including
attaching certification information to the purchase request that is communicated to the provider.
